(19) United States
(12) Patent Application Publication
(10) Pub. No.: US 2026/0010151 A1
(43) Pub. Date: Jan. 8, 2026

(54) ONLINE PRODUCT DEFECT DETECTION APPARATUS AND METHOD IN HERMETIC COMPRESSOR MANUFACTURING

(71) Applicant: ZHEJIANG UNIVERSITY OF TECHNOLOGY, Zhejiang (CN)

(72) Inventors: Xi Shen, Zhejiang (CN); Huaqiang Jin, Zhejiang (CN); Jiangping Gu, Zhejiang (CN); Zhe Sun, Zhejiang (CN); Yuejin Huang, Zhejiang (CN); Kang Li, Zhejiang (CN); Ling Shi, Zhejiang (CN); Qiwei YAO, Zhejiang (CN)

(73) Assignee: ZHEJIANG UNIVERSITY OF TECHNOLOGY, Zhejiang (CN)

(21) Appl. No.: 19/323,967

(22) Filed: Sep. 9, 2025

Related U.S. Application Data
(63) Continuation of application No. PCT/CN2024/079589, filed on Mar. 1, 2024.

(30) Foreign Application Priority Data
Mar. 31, 2023 (CN) 202310337019.4

(51) Int. Cl. G05B 23/02

(52) U.S. Cl. CPC G05B 23/0221; G05B 23/0275

(57) ABSTRACT

A product defect online detection apparatus and method in hermetic compressor manufacturing. The online detection apparatus uses a multi-channel time-frequency-space feature fusion deep learning algorithm to perform information fusion on time-frequency features of vibration signals in three directions of a housing of a complete hermetic compressor; time-frequency features and spatial features are learned and extracted to solve the identification and classification of a manufacturing defect of the hermetic compressor; and a complete compressor defect is fed back to front-end part machining and assembling stages in real time during intelligent compressor manufacturing, so as to establish an intelligent closed loop for hermetic compressor manufacturing.

### CROSS-REFERENCE TO RELATED APPLICATION

This application is a continuation of international application of PCT application NO. PCT/CN2024/079589 filed on Mar. 1, 2024, which claims the priority benefit of China application No. 202310337019.4 filed on Mar. 31, 2023. The entirety of each of the above-mentioned patent applications is hereby incorporated by reference herein and made a part of this specification.

### TECHNICAL FIELD

The present disclosure relates to the technical fields of manufacturing quality detection, vibration signal measurement, digital signal processing, and product defect online detection for compressors, and in particular to, an intelligent defect detection apparatus and method for products on a production line during hermetic compressor manufacturing, which can identify defective compressors in real time and automatically classify the defective compressors according to defect types.

### BACKGROUND

In recent years, social development and people's living standards have been increasingly improved. The application range of refrigeration equipment has become increasingly extensive, and refrigeration equipment categories have become more diverse, such as refrigerators, water dispensers, and tea and alcoholic beverage preservation cabinets in daily household use, various types of chilled freshness preservation cabinets and ice makers used in shopping malls, and medical refrigerators for preserving vaccine and blood products used in medical facilities. However, with increasingly complex operating environments and heightened energy efficiency requirements for refrigeration equipment, more stringent requirements are imposed on the quality of its core component: the hermetic refrigeration compressor. At present, China has become a major global manufacturing base for refrigeration compressors, where an output of hermetically sealed refrigeration compressors alone accounts for over 70% of worldwide production output. The refrigeration compressor manufacturing industry exhibits extensive distribution.

The hermetic refrigeration compressor, as the most complex core unit that is the most difficult to manufacture in refrigeration systems and equipment, includes multiple internal components and parts. During the manufacturing process on the production line, product defects may occur to the produced complete compressor due to factors such as unqualified machining accuracy of components and parts, improper assembly, and the like. The housing of the hermetic refrigeration compressor is a steel plate of approximately 2 mm thick. All components and parts are sealed inside the housing, and in addition to the above unobvious defects, it is extremely difficult to identify product defects based on the external features of the housing, making online detection of product defects a technology that remains to be broken through in complete compressors. Currently, the online complete hermetic refrigeration compressor detection mainly relies on manual sensory experience such as listening and touching, only defective products with particularly obvious vibrations can be detected, the types of product defects cannot be determined, and the types of product defects are determined only through subsequent dissection.

In conclusion, the technical problem urgently to be solved in the refrigeration compressor manufacturing industry is how to provide a product defect identification and classification method for the complete hermetic refrigeration compressor, particularly a product defect online detection technology and apparatus suitable for automatic compressor production line manufacturing.

### SUMMARY

To overcome the technical bottleneck in product defect automatic detection of a complete compressor during hermetic refrigeration compressor production line manufacturing, the present disclosure provides a product defect online detection apparatus and method for a hermetic compressor.

The technical solution of the present disclosure is as follows:

A product defect online detection apparatus in hermetic compressor manufacturing includes a mechanical system, where the mechanical system includes a compressor under detection, a bottom plate of the compressor, a compressor conveyor, a compressor jacking cylinder, a main detection support, a code scanner, and an auxiliary support; the bottom plate of the compressor is arranged on the compressor conveyor, and the compressor jacking cylinder is arranged below the bottom plate of the compressor; the main detection support is arranged on a side of the compressor conveyor and located at a detection point of the compressor under detection; a telescopic sensor chain is mounted at a top of the main detection support, a triaxial acceleration sensor is mounted below the telescopic sensor chain, the triaxial acceleration sensor is connected to an electromagnetic sensor mount, a detection point proximity switch is mounted in the middle of the main detection support, and a power connector of the compressor is arranged below the main detection support; and the auxiliary support is located in front of the detection point, and the code scanner is mounted on the auxiliary support and configured to scan a two-dimensional code of compressor information outside a housing of the compressor under detection.

Further, a product defect online detection apparatus in hermetic compressor manufacturing further includes a measurement and control system, where the measurement and control system includes an industrial control computer, a display, an electrical cabinet, an Ethernet bus, and a data acquisition and control unit; the industrial control computer uses the code scanner as an input device and the display as an output device; the data acquisition and control unit achieves data acquisition and real-time control of the online detection apparatus and exchanges data with the industrial control computer via the Ethernet bus; and a vibration signal acquisition module, a pulse signal output module, a digital quantity output module, and a digital quantity input module are mounted on a chassis of the data acquisition and control unit;
the vibration signal acquisition module is provided with four high-speed vibration signal acquisition channels, where three high-speed vibration signal acquisition channels are configured to respectively acquire vibration signals in directions I, J, and K, and the vibration signals in the three directions are measured by the triaxial acceleration sensor;
the pulse signal output module is capable of outputting 0-10 V high-frequency response voltage signals to provide a variable frequency driver of a variable frequency compressor with pulse signals, so as to regulate a rotational speed of the variable frequency compressor;
the digital quantity output module controls an external actuating element through an intermediate relay, and the intermediate relay is capable of playing an effective isolating role;
the digital quantity output module controls startup and shutdown of the compressor under detection, startup and shutdown of the compressor conveyor, and switching-on and switching-off of a main power supply of the online detection apparatus through the intermediate relay and a contactor;
the digital quantity output module controls the operation of the compressor jacking cylinder, the power connector of the compressor, the electromagnetic sensor mount, and a defect alarm indicator through the intermediate relay; and
the digital quantity input module receives signals of the detection point proximity switch and an equipment abnormality alarm, and transmits input signals to the data acquisition and control unit.

Further, the power connector of the compressor is capable of automatically telescoping. During detection, the power connector of the compressor extends to contact with a three-pin power socket of the compressor under detection, so as to provide the compressor under detection with a power supply.

A detection method for a product defect online detection apparatus in hermetic compressor manufacturing, including the following steps:
1) When detection is started, conveying a compressor manufactured in an assembly line to the compressor conveyor, starting, by the online detection apparatus, the compressor conveyor, and conveying the compressor under detection to a detection point;
2) When the detection point proximity switch detects the compressor under detection, stopping the compressor conveyor, where the compressor under detection remains at the detection point, and scanning, by the code scanner, the two-dimensional code of the compressor information on the housing of the compressor under detection and automatically recording various production information of the compressor under detection;
3) Lifting, by the compressor jacking cylinder, the bottom plate of the compressor, and energizing the electromagnetic sensor mount, where the triaxial acceleration sensor is tightly connected to the housing of the compressor under detection, the power connector of the compressor extends and is connected to the three-pin power socket of the compressor under detection, and the compressor under detection is energized to operate;
4) Sampling the vibration signals in the three directions of the housing of the compressor under detection through the triaxial acceleration sensor, and when sampling time reaches set time, stopping sampling of vibration data, where the electromagnetic sensor mount is deenergized, the power connector of the compressor retracts, and the compressor jacking cylinder is lowered and returns to the original position;
5) Analyzing the vibration signals in the three directions by means of the embedded deep learning algorithm, and determining whether the compressor under detection has defects, where in a case where the compressor under detection has defects, corresponding defect classification is performed, the defect alarm indicator comes on, and the defective product is conveyed to an abnormal product area through the compressor conveyor, and in a case where compressor under detection has no defects, the compressor under detection is conveyed to a next step through the compressor conveyor; and
6) Displaying and counting detection results in real time, counting a proportion and number of various defect types and displaying a proportion and number by means of pie charts, and counting a production volume of the assembly line, the number of qualified products, the number of the defective products, and a defective rate of products.

Further, a specific process of determining and classifying defects in step 5) is as follows:
5.1) Vibration signal acquisition: sampling, by the triaxial acceleration sensor, the vibration signals in the three directions of the housing of the compressor under detection, and then automatically capturing 5-10 working cycles from the sampled data as original analytical data;
5.2) Signal denoising and enhancement: parsing the original analytical data as spectral signals in different frequency bands by a modal decomposition method, and removing spectral signals of interference noise of the production line;
5.3) Signal-reconstructed images: reconstructing residual spectral signals without the interference noise of the production line, and then converting the reconstructed vibration signals into image signals, thereby facilitating subsequent feature extraction by a deep convolutional neural network;
5.4) Multi-layer convolution for feature extraction: performing multi-layer convolution and pooling on the reconstructed images in the three directions according to respective channels to extract defect features, a convolutional pooling architecture of each layer consists of a convolutional layer, a batch normalization layer, and a pooling layer, and the convolutional pooling architectures are in serial connection in sequence to achieve feature learning and extraction of the reconstructed images in the three directions;
5.5) Defect feature fusion: after convolutional pooling feature extraction of the reconstructed images in the three directions, unfolding the defect features by a flatten layer according to respective channels, and then fusing and splicing the defect features of the three channels through a fully connected layer to achieve fusion of defect feature information in the three directions; and
5.6) Classified output of the defects: deciding the types of the product defects by means of a classification layer, and finally, outputting classification results.

Further, a multi-channel time-frequency fusion deep learning algorithm is employed for the defect identification and classification in step 5) to perform information fusion on time-frequency features of the vibration signals in the three directions of the hermetic compressor, so as to automatically learn the time-frequency features and spatial features of the defects, thereby effectively improving the detection accuracy of the online detection apparatus.

The detection apparatus can identify and classify the defective products in automated production line manufacturing of the hermetic compressor, breaks through a bottleneck stage in the intelligent manufacturing process of the hermetic compressor, feeds the complete compressor defect back to front-end part machining and assembling stages in real time during intelligent compressor manufacturing, so as to establish an intelligent closed loop for hermetic compressor manufacturing. The online detection apparatus consists of products under detection, the mechanical system, and the measurement and control system.

The products under detection refer to hermetic compressors that have been completely mounted on the production line, including the compressor under detection, and compressors to be detected and compressors that have been detected.

The measurement and control system mainly consists of the industrial control computer, the display, the data acquisition and control unit, the triaxial acceleration sensor, and the like. The triaxial acceleration sensor may acquire the vibration signals in the three directions of the housing outside the compressor.

The mechanical system is a main portion of the online detection apparatus and mainly includes the bottom plate of the compressor under detection, the compressor conveyor, the compressor jacking cylinder, the main detection support, the auxiliary support, and the like.

The code scanner is mounted on the auxiliary support and is capable of scanning the two-dimensional code of the compressor information outside the housing of the compressor under detection, such that the product information of the compressor under detection is automatically acquired.

By using the industrial control computer as a data processing core, the measurement and control system in the present disclosure achieves defect identification and classification of the products manufactured in the production line of the hermetic compressor.

By using the display as an output device, the industrial control computer achieves the operating functions of application software, including functions such as system parameter setting, identification and classification of the defective products, and production data counting.

By using the code scanner as an input device, the industrial control computer achieves automatic acquisition of various production information of the compressor under detection.

The data acquisition and control unit achieves data acquisition and real-time control of the online detection apparatus and exchanges data with the industrial control computer via the Ethernet bus.

The vibration signal acquisition module, the pulse signal output module, the digital quantity output module, and the digital quantity input module are mounted on the chassis of the data acquisition and control unit.

The vibration signal acquisition module is provided with four high-speed vibration signal acquisition channels, where three high-speed vibration signal acquisition channels are configured to respectively acquire the vibration signals in the three directions, and the vibration signals are measured by the triaxial acceleration sensor.

The pulse signal output module may output 0-10 V high-frequency response voltage signals to provide a variable frequency driver of a variable frequency compressor with pulse signals, so as to regulate a rotational speed of the variable frequency compressor.

The digital quantity output module controls the external actuating element through the intermediate relay and a contactor.

The digital quantity input module receives signals of the detection point proximity switch and the equipment abnormality alarm.

In terms of design and development, the application software in the present disclosure is programmed by employing a graphical editing language, and a resulting program is in a block diagram form, which is suitable for the rapid development of window-based applications.

The application software for the online detection apparatus is no longer limited to pure data acquisition and equipment control and further has the functions of system parameter setting, product information scanning and inputting, model self-learning, product defect detection, data management, interface display, and the like. A relational database management system is employed in the data management of the application software.

By adopting the above technology, compared with the prior art, the present disclosure has the following beneficial effects:
1) The detection apparatus is capable of achieving online detection of product defects of the complete hermetic compressor during production line manufacturing, may not only determine whether the product has defects, but also classify the defect type, and feeds the complete compressor defect back to front-end part machining and assembling stages in real time during intelligent compressor manufacturing, so as to establish an intelligent closed loop for hermetic compressor manufacturing.
2) The multi-channel time-frequency fusion deep learning algorithm is employed for the defect identification and classification method of the detection apparatus to perform information fusion on time-frequency features of the vibration signals in the three directions of the hermetic compressor, so as to automatically learn the time-frequency features and spatial features of the defects, thereby effectively improving the detection accuracy of the online detection apparatus.
3) The online detection apparatus has relatively high degree of intellectualization, can automatically complete the whole defect detection process under a production takt of a compressor manufacturing line, and compiles statistics and performs feedback on data such as the type and proportion of a product defect, the number of defective products, the number of qualified products, the gross production of the product, and the defective rate of products during a manufacturing process.

### BRIEF DESCRIPTION OF THE DRAWINGS

FIG. 1 is a schematic diagram of an external structure of an apparatus according to the present disclosure.

FIG. 2 is a hardware frame diagram of a control system of the apparatus according to the present disclosure.

FIG. 3 is a functional frame diagram of application software of the apparatus according to the present disclosure.

FIG. 4 is a frame diagram of a defect identification and classification method of the apparatus according to the present disclosure.

FIG. 5 is a test flow chart of the apparatus according to the present disclosure.

In the figures: 1, industrial control computer; 2, display; 3, electrical cabinet; 4, main detection support; 5, telescopic sensor chain; 6, triaxial acceleration sensor; 7, electromagnetic sensor mount; 8, compressor under detection; 9, two-dimensional code of compressor information; 10, bottom plate of compressor; 11, code scanner; 12, auxiliary support; 13, compressor conveyor; 14, compressor jacking cylinder; 15, power connector of compressor; 16, detection point proximity switch; 17, Ethernet bus; 18, data acquisition and control unit; 19, vibration signal acquisition module; 20, pulse signal output module; 21, digital quantity output module; 22, digital quantity input module; 23, variable frequency driver; 24, contactor; 25, intermediate relay; 26, main power supply of the online detection apparatus; 27, defect alarm indicator; and 28, equipment abnormality alarm.

### DETAILED DESCRIPTIONS OF THE EMBODIMENTS

The present disclosure will be further described below in conjunction with drawings of the specification, but the protection scope of the present disclosure is not limited thereto:

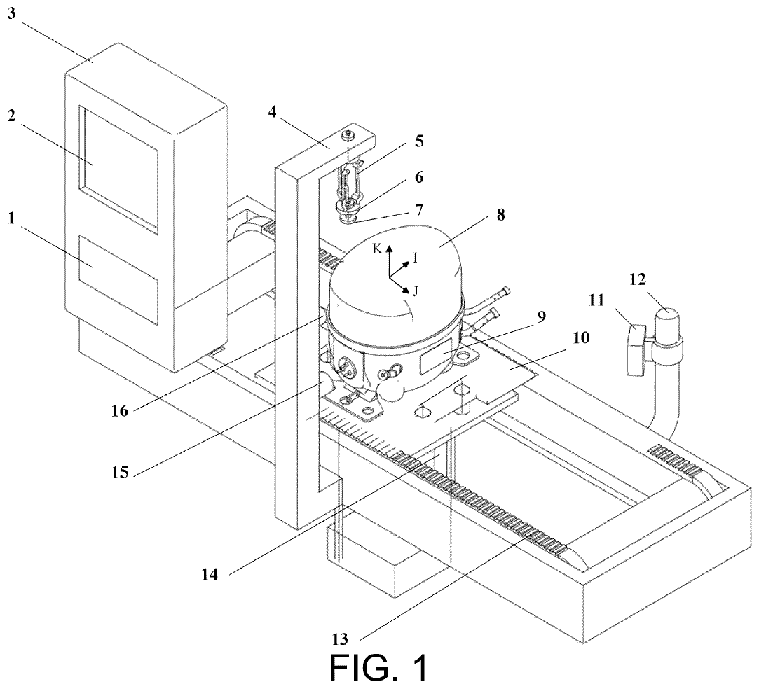

The external structure of the online detection apparatus in this embodiment is shown in FIG. 1. The detection apparatus can identify and classify the defective products in automated production line manufacturing of the hermetic compressor, breaks through a bottleneck stage in the intelligent manufacturing process of the hermetic compressor, feeds the complete compressor defect back to front-end part machining and assembling stages in real time during intelligent compressor manufacturing, so as to establish an intelligent closed loop for hermetic compressor manufacturing.

The online detection apparatus consists of products under detection, the mechanical system, and the measurement and control system. The products under detection refer to hermetic compressors that have been completely mounted on the production line, including the compressor under detection 8, and compressors to be detected and compressors that have been detected. The measurement and control system is mounted in the electrical cabinet 3 and mainly includes the industrial control computer 1, the display 2, and components and parts related to data acquisition and control. The mechanical system is a main portion of the online detection apparatus and mainly includes the bottom plate 10 of the compressor under detection, the compressor conveyor 13, the compressor jacking cylinder 14, the main detection support 4, the auxiliary support 12, and the like. The compressor under detection 8 is mounted on the bottom plate 10 of the compressor, and the bottom plate 10 of the compressor may be flow-conveyed on the compressor conveyor 13. The main detection support 4 is located at a position where the compressor 8 under detection is detected. The power connector 15 of the compressor is mounted first below the main detection support, and the power connector 15 of the compressor may telescope automatically. During detection, the power connector 15 of the compressor extends to contact with a three-pin power socket of the compressor 8 under detection, so as to provide the compressor 8 under detection with a power supply; and when detection is finished, the power connector 15 of the compressor retracts to deenergize the power supply of the compressor 8 under detection. The detection point proximity switch 16 is mounted in the middle of the main detection support 4. The detection point proximity switch 16 is an infrared inductive proximity switch. When the detection point proximity switch detects that the compressor 8 under detention reaches the detection point, the detection point proximity switch transmits signals to the online detection apparatus, and the online detection apparatus stops movement of the compressor conveyor 13. The telescopic sensor chain 5 is mounted at the top of the main detection support 4, the triaxial acceleration sensor 6 is mounted below the telescopic sensor chain 5, and the triaxial acceleration sensor 6 is connected to the electromagnetic sensor mount 7. When the compressor 8 under detection is detected, the compressor jacking cylinder 14 jacks the bottom plate 10 of the compressor and the compressor 8 under detection to a certain position. After the electromagnetic sensor mount 7 is energized, the triaxial acceleration sensor 6 is tightly connected to the housing of the compressor 8 under detection through the electromagnetic sensor mount 7. The auxiliary support 12 is located in front of the detection point, and the code scanner 11 is mounted on the auxiliary support 12. When the compressor 8 under detection approaches to or reaches the detection point, the code scanner 11 scans the two-dimensional code 9 of the compressor information outside the housing of the compressor 8 under detection, such that the product information of the compressor under detection is automatically acquired.

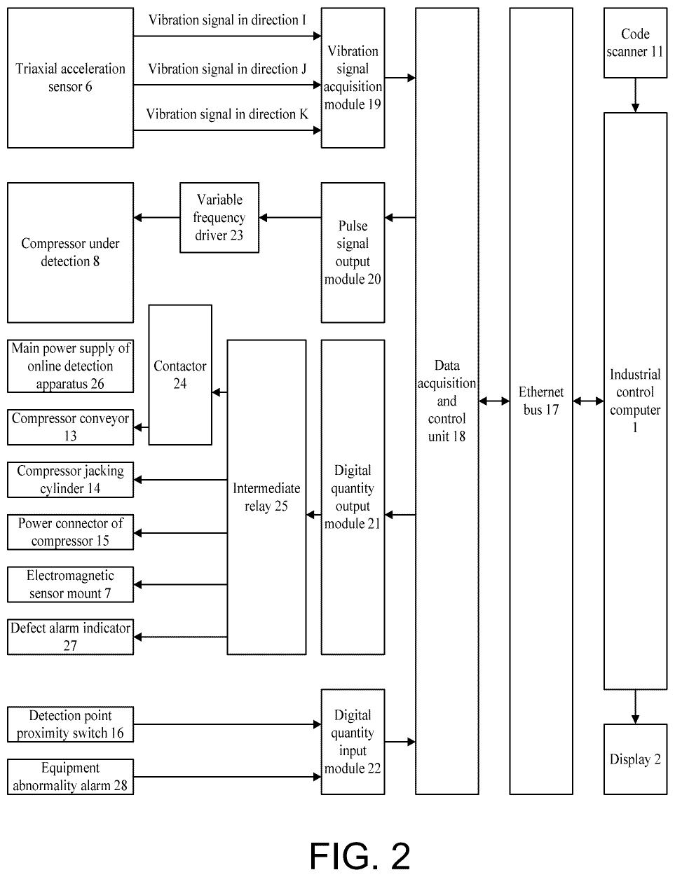

The frame diagram of software of the measurement and control system of the online detection apparatus in this embodiment is shown in FIG. 2. By using the industrial control computer 1 as a data processing core, the measurement and control system in the present disclosure achieves defect identification and classification of the products manufactured in the production line of the hermetic compressor. By using the display 2 as an output device, the industrial control computer 1 achieves the operating functions of application software, including functions such as system parameter setting, identification and classification of the defective products, and production data counting. By using the code scanner 11 as an input device, the industrial control computer 1 achieves automatic acquisition of various production information of the compressor 8 under detection. The data acquisition and control unit 18 achieves data acquisition and real-time control of the online detection apparatus and exchanges data with the industrial control computer 1 via the Ethernet bus 17. The vibration signal acquisition module 19, the pulse signal output module 20, the digital quantity output module 21, and the digital quantity input module 22 are mounted on the chassis of the data acquisition and control unit 18. The vibration signal acquisition module 19 is provided with four high-speed vibration signal acquisition channels, where three high-speed vibration signal acquisition channels are configured to respectively acquire vibration signals in directions I, J, and K, and the vibration signals in the three directions are measured by the triaxial acceleration sensor 6. The pulse signal output module 20 may output 0-10 V high-frequency response voltage signals to provide a variable frequency driver 23 of a variable frequency compressor with pulse signals, so as to regulate a rotational speed of the variable frequency compressor. The digital quantity output module 21 controls an external actuating element through an intermediate relay 25, and the intermediate relay 25 may play an effective isolating role. The digital quantity output module 21 controls startup and shutdown of the compressor 8 under detection, startup and shutdown of the compressor conveyor 13, and switching-on and switching-off of the main power supply 26 of the online detection apparatus through the intermediate relay 25 and a contactor 24. The digital quantity output module 21 controls the operation of the compressor jacking cylinder 14, the power connector 15 of the compressor, the electromagnetic sensor mount 7, and a defect alarm indicator 27 through the intermediate relay 25. The digital quantity input module 22 receives signals of the detection point proximity switch 16 and an equipment abnormality alarm 28, and transmits input signals to the data acquisition and control unit 18.

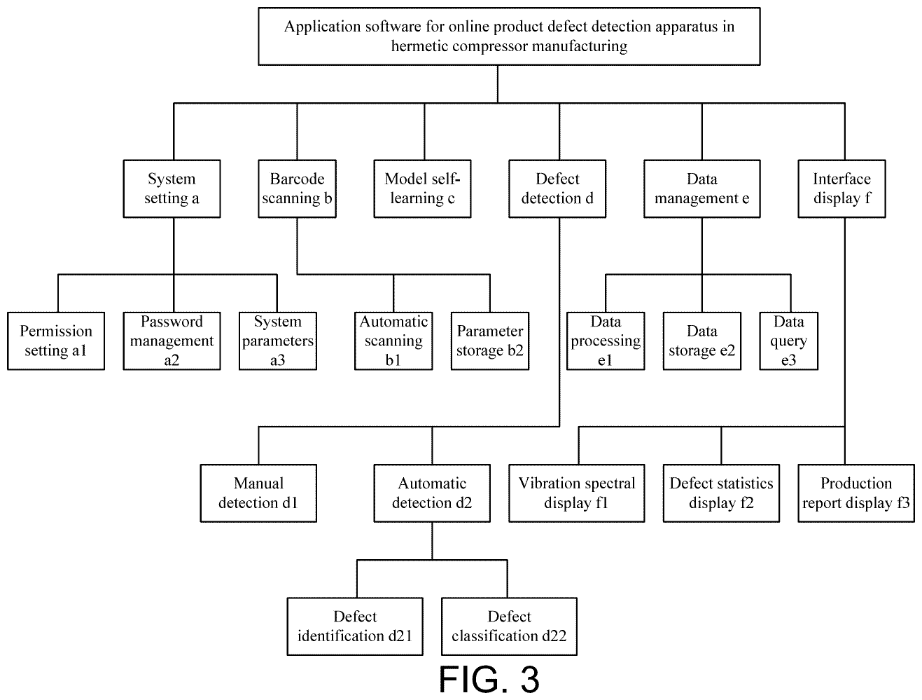

In terms of design and development, the application software in the present disclosure is programmed by employing a graphical editing language, and a resulting program is in a block diagram form, which is suitable for the rapid development of window-based applications. The functional block diagram of the application software is shown in FIG. 3. The application software for measurement and control is no longer limited to pure data acquisition and equipment control and further has the functions of system parameter setting, product information scanning and inputting, model self-learning, product defect detection, data management, interface display, and the like. The data management of the application software employs MySQL, which is a relational database management system from MySQLAB. The most prominent feature of this database is its open-source nature.

The functions of the application software of the online detection apparatus in the present disclosure include system setting a, information scanning b, model self-learning c, defect detection d, data management e, and interface display f. Each functional module is specifically as follows:
(1) The system setting a is mainly responsible for completing user permission setting a1, user password management a2, system parameter setting a3, and the like. The user permissions are categorized into a production administrator and an ordinary operator. The production administrator has the highest permission and can use all functions of the application software, including functions such as user permission setting a1 and system parameter setting a3, and the ordinary operator can only use part of the functions of the application software to complete the entire online detection process, and cannot use advanced functions such as user setting a1 and system parameter setting a3;
(2) Information scanning b is mainly responsible for completing information input of the two-dimensional code of the compressor information on the housing of the compressor 8 under detection in the production line, including a compressor number, a compressor steel number, a production batch, a production line number, detector information, and the like;
(3) Model self-learning c is mainly responsible for completing self-learning and model re-training of the embedded deep learning algorithm of the online detection apparatus, such that the embedded deep learning algorithm is capable of learning new defect types, new product type and model of the compressor, thereby increasing the accuracy of the online detection apparatus that identifies and classifies the defective products and improving the robustness and universality of the embedded deep learning algorithm of the online detection apparatus;
(4) Defect detection d includes manual detection d1 and automatic detection d2. In the state of manual detection d1, startup, shutdown, and rotational speed of the compressor 8 under detection may be manually controlled, the vibration signals of the housing are measured, and defect identification and classification is then performed; in the state of automatic detection d2, the detection system will perform full-automatic online detection according to set system parameters, and after two processes of defect identification d21 and defect classification d22, the entire detection process is completed;
(5) Data management e is responsible for managing online detection data, including data processing e1, data storage e2, data query e3. Recording and storing product data and operating state during online detection is an important task of the application software. By analyzing and processing the vibration data of the housing, whether the compressor under detection has defects may be determined. In a case where the compressor under detection has defects, defect classification is performed according to vibration feature performance of the compressor under detection;
(6) Interface display f is mainly responsible for achieving vibration spectral display f1, defect statistics display f2, and production report display f3, where the vibration spectral display f1 is mainly responsible for displaying a frequency spectrogram of vibration data in three directions acquired by the triaxial acceleration sensor 6 after time-frequency transform. Defect statistics display f2 is mainly responsible for counting the number of compressors with various defect types detected and the corresponding proportion of defects, and the number of compressors with various defect types defected and the corresponding proportion of defects are represented by a pie chart. Production report display f3 is mainly responsible for displaying various production information of the compressor assembly line, such as the gross production, the number of qualified products, the number of defective products, and the defective rate of products.

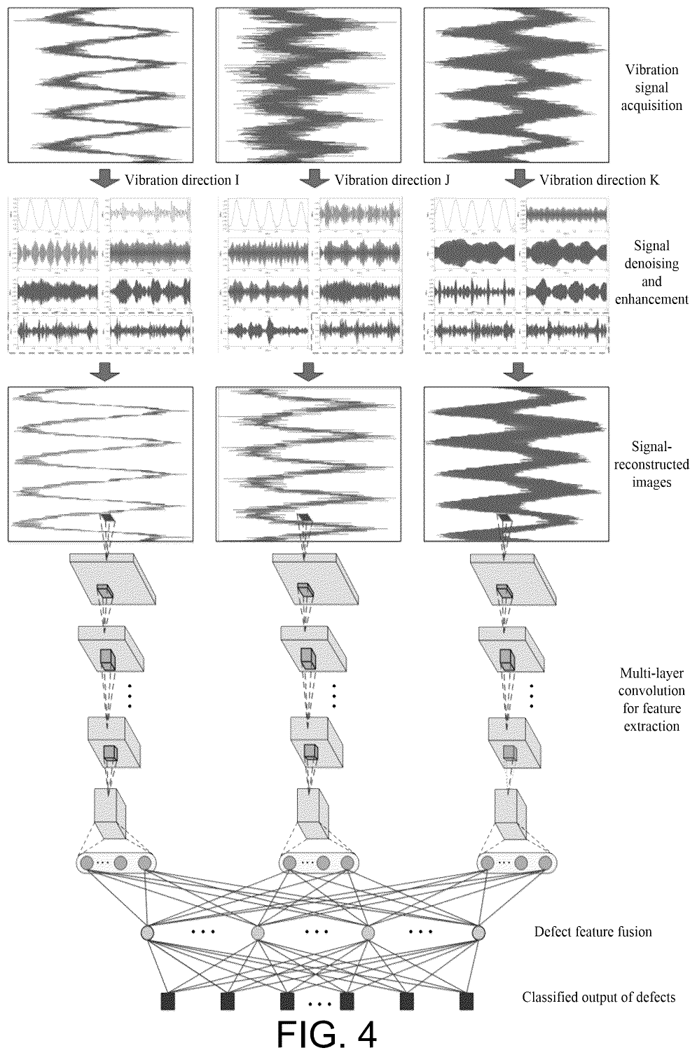

According to the product defect online detection method for a hermetic compressor in this embodiment, the defect identification and classification method is shown in FIG. 4, specifically including the following steps:
(1) Vibration signal acquisition: the triaxial acceleration sensor 6 samples the vibration signals in the three directions of the housing of the compressor 8 under detection, and then automatically captures 5 working cycles from the sampled data as original analytical data;
(2) Signal denoising and enhancement: the original analytical data is parsed as spectral signals in 8 different frequency bands by a modal decomposition method, and spectral signals of interference noise of the production line are removed, where the spectral signals in the dashed box in FIG. 4 indicate the interference noise;
(3) Signal-reconstructed images: residual spectral signals without the interference noise of the production line are reconstructed, and then the reconstructed vibration signals are converted into image signals, thereby facilitating subsequent feature extraction by a deep convolutional neural network;
(4) Multi-layer convolution for feature extraction: multi-layer convolution and pooling are performed on the reconstructed images in the three directions according to respective channels to extract defect features, where a convolutional pooling architecture of each layer consists of a convolutional layer, a batch normalization layer, and a pooling layer, and the convolutional pooling architectures are in serial connection in sequence to achieve feature learning and extraction of the reconstructed images in the three directions;
(5) Defect feature fusion: after convolutional pooling feature extraction of the reconstructed images in the three directions, the defect features are unfolded by a flatten layer according to respective channels, and then the defect features of the three channels are fused and spliced through a fully connected layer to achieve fusion of defect feature information in the three directions; and
(6) Classified output of the defects: the types of the product defects are decided by means of a classification layer, and finally, classification results are outputted.

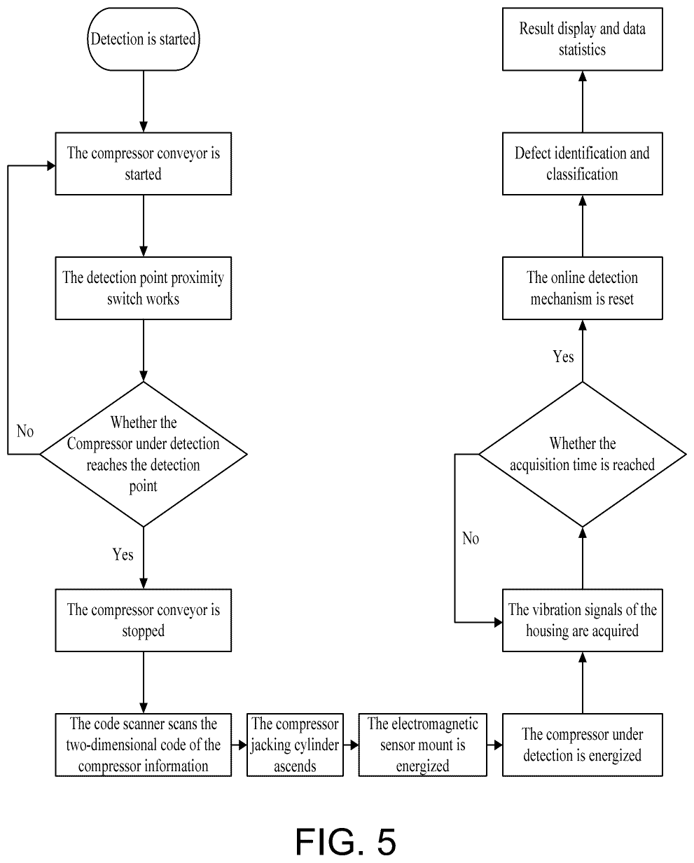

The product defect online detection method for a hermetic compressor in this embodiment, with a detection process shown in FIG. 5, specifically includes the following steps:
(1) When detection is started, a compressor manufactured in an assembly line is conveyed to the compressor conveyor 13, and the online detection apparatus starts the compressor conveyor 13 and conveys the compressor under detection 8 to a detection point;
(2) When the detection point proximity switch 16 detects the compressor under detection 8, the online detection apparatus stops the compressor conveyor 13, where the compressor under detection 8 remains at the detection point, and the code scanner 11 scans the two-dimensional code 9 of the compressor information on the housing of the compressor under detection 8 and automatically records various production information of the compressor under detection 8;
(3) The compressor jacking cylinder 14 lifts the bottom plate 10 of the compressor, and the electromagnetic sensor mount 7 is energized, where the triaxial acceleration sensor 6 is tightly connected to the housing of the compressor under detection 8, the power connector 15 of the compressor extends and is connected to the three-pin power socket of the compressor under detection 8, and the compressor under detection 8 is energized to operate;
(4) The online detection apparatus samples the vibration signals in the three directions of the housing of the compressor under detection 8 through the triaxial acceleration sensor 6, and when sampling time reaches set time, sampling of vibration data is stopped, where the electromagnetic sensor mount 7 is deenergized, the power connector 15 of the compressor retracts, and the compressor jacking cylinder 14 is lowered and returns to the original position;
(5) The online detection apparatus analyzes the vibration signals in the three directions by means of the embedded deep learning algorithm, and determines whether the compressor under detection 8 has defects, where in a case where the compressor under detection has defects, corresponding defect classification is performed, the defect alarm indicator 27 comes on, and the defective product is conveyed to an abnormal product area through the compressor conveyor 13, and in a case where compressor under detection has no defects, the compressor under detection is conveyed to a next step through the compressor conveyor 13; and
(6) The online detection apparatus displays and counts detection results in real time, counts a proportion and number of various defect types and displays a proportion and number by means of pie charts, and counts a production volume of the assembly line, the number of qualified products, the number of the defective products, and a defective rate of products.

What is claimed is:

1. A product defect online detection apparatus in hermetic compressor manufacturing, comprising a mechanical system, wherein the mechanical system comprises a compressor under detection, a bottom plate of the compressor, a compressor conveyor, a compressor jacking cylinder, a main detection support, a code scanner, and an auxiliary support; the bottom plate of the compressor is arranged on the compressor conveyor, and the compressor jacking cylinder is arranged below the bottom plate of the compressor; the main detection support is arranged on a side of the compressor conveyor and located at a detection point of the compressor under detection; a telescopic sensor chain is mounted at a top of the main detection support, a triaxial acceleration sensor is mounted below the telescopic sensor chain, the triaxial acceleration sensor is connected to an electromagnetic sensor mount, a detection point proximity switch is mounted in the middle of the main detection support, and a power connector of the compressor is arranged below the main detection support; and the auxiliary support is located in front of the detection point, and the code scanner is mounted on the auxiliary support and configured to scan a two-dimensional code of compressor information outside a housing of the compressor under detection;
wherein the product defect online detection apparatus in hermetic compressor manufacturing further comprises a measurement and control system, where the measurement and control system comprises an industrial control computer, a display, an electrical cabinet, an Ethernet bus, and a data acquisition and control unit; the industrial control computer uses the code scanner as an input device and the display as an output device; the data acquisition and control unit achieves data acquisition and real-time control of the online detection apparatus and exchanges data with the industrial control computer via the Ethernet bus; and a vibration signal acquisition module, a pulse signal output module, a digital quantity output module, and a digital quantity input module are mounted on a chassis of the data acquisition and control unit;
the vibration signal acquisition module is provided with four high-speed vibration signal acquisition channels, wherein three high-speed vibration signal acquisition channels are configured to respectively acquire vibration signals in directions I, J, and K, and the vibration signals in the three directions are measured by the triaxial acceleration sensor;
the pulse signal output module is capable of outputting 0-10 V high-frequency response voltage signals to provide a variable frequency driver of a variable frequency compressor with pulse signals, so as to regulate a rotational speed of the variable frequency compressor;
the digital quantity output module controls an external actuating element through an intermediate relay, and the intermediate relay is capable of playing an effective isolating role;
the digital quantity output module controls startup and shutdown of the compressor under detection, startup and shutdown of the compressor conveyor, and switching-on and switching-off of a main power supply of the online detection apparatus through the intermediate relay and a contactor;
the digital quantity output module controls the operation of the compressor jacking cylinder, the power connector of the compressor, the electromagnetic sensor mount, and a defect alarm indicator through the intermediate relay; and
the digital quantity input module receives signals of the detection point proximity switch and an equipment abnormality alarm, and transmits input signals to the data acquisition and control unit.

2. The product defect online detection apparatus in hermetic compressor manufacturing according to claim 1, wherein the power connector of the compressor is capable of automatically telescoping, and during detection, the power connector of the compressor extends to contact with a three-pin power socket of the compressor under detection, so as to provide the compressor under detection with a power supply.

3. A detection method for the product defect online detection apparatus in hermetic compressor manufacturing according to claim 1, comprising the following steps:
1) When detection is started, conveying a compressor manufactured in an assembly line to the compressor conveyor, starting, by the online detection apparatus, the compressor conveyor, and conveying the compressor under detection to a detection point;
2) When the detection point proximity switch detects the compressor under detection, stopping the compressor conveyor, where the compressor under detection remains at the detection point, and scanning, by the code scanner, the two-dimensional code of the compressor information on the housing of the compressor under detection and automatically recording various production information of the compressor under detection;
3) Lifting, by the compressor jacking cylinder, the bottom plate of the compressor, and energizing the electromagnetic sensor mount, where the triaxial acceleration sensor is tightly connected to the housing of the compressor under detection, the power connector of the compressor extends and is connected to the three-pin power socket of the compressor under detection, and the compressor under detection is energized to operate;
4) Sampling the vibration signals in the three directions of the housing of the compressor under detection through the triaxial acceleration sensor, and when sampling time reaches set time, stopping sampling of vibration data, where the electromagnetic sensor mount is deenergized, the power connector of the compressor retracts, and the compressor jacking cylinder is lowered and returns to the original position;
5) Analyzing the vibration signals in the three directions by means of the embedded deep learning algorithm, and determining whether the compressor under detection has defects, wherein in a case where the compressor under detection has defects, corresponding defect classification is performed, the defect alarm indicator comes on, and the defective product is conveyed to an abnormal product area through the compressor conveyor, and in a case where the compressor under detection has no defects, the compressor under detection is conveyed to a next step through the compressor conveyor;
a specific process of identifying and classifying defects in step 5) is as follows:
5.1, vibration signal acquisition: sampling, by the triaxial acceleration sensor, the vibration signals in the three directions of the housing of the compressor under detection, and then automatically capturing 5-10 working cycles from the sampled data as original analytical data;
5.2, signal denoising and enhancement: parsing the original analytical data as spectral signals in different frequency bands by a modal decomposition method, and removing spectral signals of interference noise of the production line;
5.3, signal-reconstructed images: reconstructing residual spectral signals without the interference noise of the production line, and then converting the reconstructed vibration signals into image signals, thereby facilitating subsequent feature extraction by a deep convolutional neural network;
5.4, multi-layer convolution for feature extraction: performing multi-layer convolution and pooling on the reconstructed images in the three directions according to respective channels to extract defect features, a convolutional pooling architecture of each layer consists of a convolutional layer, a batch normalization layer, and a pooling layer, and the convolutional pooling architectures are in serial connection in sequence to achieve feature learning and extraction of the reconstructed images in the three directions;
5.5, defect feature fusion: after convolutional pooling feature extraction of the reconstructed images in the three directions, unfolding the defect features by a flatten layer according to respective channels, and then fusing and splicing the defect features of the three channels through a fully connected layer to achieve fusion of defect feature information in the three directions; and
5.6, classified output of the defects: deciding the types of the product defects by means of a classification layer, and finally, outputting classification results; and
6) Displaying and counting detection results in real time, counting a proportion and number of various defect types and displaying a proportion and number by means of pie charts, and counting a production volume of the assembly line, the number of qualified products, the number of the defective products, and a defective rate of products.

4. The detection method for the product defect online detection apparatus in hermetic compressor manufacturing according to claim 3, wherein a multi-channel time-frequency fusion deep learning algorithm is employed for the defect identification and classification in step 5) to perform information fusion on time-frequency features of the vibration signals in the three directions of the hermetic compressor, so as to automatically learn the time-frequency features and spatial features of the defects, thereby effectively improving the detection accuracy of the online detection apparatus.

5. A detection method for the online product defect detection apparatus in hermetic compressor manufacturing according to claim 2, comprising the following steps:
1) When detection is started, conveying a compressor manufactured in an assembly line to the compressor conveyor, starting, by the online detection apparatus, the compressor conveyor, and conveying the compressor under detection to a detection point;
2) When the detection point proximity switch detects the compressor under detection, stopping the compressor conveyor, where the compressor under detection remains at the detection point, and scanning, by the code scanner, the two-dimensional code of the compressor information on the housing of the compressor under detection and automatically recording various production information of the compressor under detection;
3) Lifting, by the compressor jacking cylinder, the bottom plate of the compressor, and energizing the electromagnetic sensor mount, where the triaxial acceleration sensor is tightly connected to the housing of the compressor under detection, the power connector of the compressor extends and is connected to the three-pin power socket of the compressor under detection, and the compressor under detection is energized to operate;
4) Sampling the vibration signals in the three directions of the housing of the compressor under detection through the triaxial acceleration sensor, and when sampling time reaches set time, stopping sampling of vibration data, where the electromagnetic sensor mount is deenergized, the power connector of the compressor retracts, and the compressor jacking cylinder is lowered and returns to the original position;
5) Analyzing the vibration signals in the three directions by means of the embedded deep learning algorithm, and determining whether the compressor under detection has defects, wherein in a case where the compressor under detection has defects, corresponding defect classification is performed, the defect alarm indicator comes on, and the defective product is conveyed to an abnormal product area through the compressor conveyor, and in a case where the compressor under detection has no defects, the compressor under detection is conveyed to a next step through the compressor conveyor;
a specific process of identifying and classifying defects in step 5) is as follows:
5.1, vibration signal acquisition: sampling, by the triaxial acceleration sensor, the vibration signals in the three directions of the housing of the compressor under detection, and then automatically capturing 5-10 working cycles from the sampled data as original analytical data;
5.2, signal denoising and enhancement: parsing the original analytical data as spectral signals in different frequency bands by a modal decomposition method, and removing spectral signals of interference noise of the production line;
5.3, signal-reconstructed images: reconstructing residual spectral signals without the interference noise of the production line, and then converting the reconstructed vibration signals into image signals, thereby facilitating subsequent feature extraction by a deep convolutional neural network;
5.4, multi-layer convolution for feature extraction: performing multi-layer convolution and pooling on the reconstructed images in the three directions according to respective channels to extract defect features, a convolutional pooling architecture of each layer consists of a convolutional layer, a batch normalization layer, and a pooling layer, and the convolutional pooling architectures are in serial connection in sequence to achieve feature learning and extraction of the reconstructed images in the three directions;
5.5, defect feature fusion: after convolutional pooling feature extraction of the reconstructed images in the three directions, unfolding the defect features by a flatten layer according to respective channels, and then fusing and splicing the defect features of the three channels through a fully connected layer to achieve fusion of defect feature information in the three directions; and
5.6, classified output of the defects: deciding the types of the product defects by means of a classification layer, and finally, outputting classification results; and
6) Displaying and counting detection results in real time, counting a proportion and number of various defect types and displaying a proportion and number by means of pie charts, and counting a production volume of the assembly line, the number of qualified products, the number of the defective products, and a defective rate of products.

6. The detection method for the online product defect detection apparatus in hermetic compressor manufacturing according to claim 5, wherein a multi-channel time-frequency fusion deep learning algorithm is employed for the defect identification and classification in step 5) to perform information fusion on time-frequency features of the vibration signals in the three directions of the hermetic compressor, so as to automatically learn the time-frequency features and spatial features of the defects, thereby effectively improving the detection accuracy of the online detection apparatus.
